(19) United States
(12) Patent Application Publication
(10) Pub. No.: US 2024/0112573 A1
(43) Pub. Date: Apr. 4, 2024

(54) SYSTEM AND METHOD FOR V2X TRANSMISSION CONGESTION CONTROL BASED ON SAFETY RELEVANCE AND MOVEMENT SIMILARITY

(71) Applicant: AUTOTALKS LTD., Kfar Netter (IL)

(72) Inventor: Onn Haran, Kfar Netter (IL)

(21) Appl. No.: 18/457,429

(22) Filed: Aug. 29, 2023

Related U.S. Application Data
(60) Provisional application No. 63/509,300, filed on Jun. 21, 2023.
(60) Provisional application No. 63/412,892, filed on Oct. 4, 2022.

(51) Int. Cl. G08G 1/01; B60W 60/00; H04W 4/40

(52) U.S. Cl. CPC G08G 1/0145; B60W 60/0015; H04W 4/40; B60W 2554/4044; B60W 2554/806; B60W 2556/45; B60W 2756/10

(57) ABSTRACT

In a vehicle-to-everything (V2X) environment and by a self-vehicle, methods and systems therefor, the methods comprising calculating a safety relevance value of a sensor detected road user or calculating a first movement similarity between the self-vehicle and a road user ahead or behind the self-vehicle and a second movement similarity between a sensor detected road user and a road user ahead or behind the sensor detected road user, and adjusting Dynamic Congestion Control (DCC) triggering condition parameters based on the calculated safety relevance value or based on the calculated first and/or second movement similarities.

### CROSS REFERENCE TO RELATED APPLICATIONS

This application claims priority from US Provisional Patent Applications No. 63/412,892 filed Oct. 4, 2022 and 63/509,300 filed Jun. 21, 2023, which are expressly incorporated herein by reference in their entirety.

### FIELD

Embodiments disclosed herein relate generally to vehicle-to-everything (V2X) communications and in particular to V2X transmission congestion control.

### BACKGROUND

One of the most studied aspects of V2X involves assuring communication performance when many road users attempt to use the same V2X wireless channel. Multiple congestion control algorithms have been developed to address this subject. These algorithms effectively adjust the transmissions of V2X Day1 (see below) services, where each road user transmits its kinematics and properties, into a single channel. A known Dynamic Congestion Control (DCC) algorithm supports congestion control of the existing services and new services.

Day2 services will increase the bandwidth needs beyond the capacity of a single channel. One known art solution is to add another channel to handle new services. However, this increases the overall cost. The cost has to be paid in advance even if the first (single) channel is currently far from being congested. A new solution is preferred, in which the congestion control algorithm is further improved to fit the new services into the single channel.

The most common congestion control algorithm, as defined by the European Telecommunications Standards Institute (ETSI), lowers the transmission rate based on the similarity of self-vehicle movement properties relative to a previous transmission. The algorithm uses only self-vehicle data and is optimized for that data.

It would be desirable to fit in a single channel both self-reporting of self-vehicle parameters (V2X Day1) and reporting of unconnected road users (V2X Day2). Hereinafter “method” and “algorithm” may be used interchangeably.

### SUMMARY

In exemplary embodiments there are disclosed methods comprising: in a V2X environment and by a self-vehicle, calculating a safety relevance value of a sensor detected road user and adjusting DCC triggering condition parameters based on the calculated safety relevance value.

In some examples, the calculating the safety relevance value of a sensor detected road user includes categorizing V2X detected road users by respective directions of arrival relative to the self-vehicle and checking an arrival time of each sensor detected road user in each category.

In some examples, the adjusting the DCC triggering condition parameters includes, by the self-vehicle or by a sensor detected road user found to be non-safety relevant, increasing from a previously transmitted value a respective value of a parameter selected from the group consisting of a minimal distance travelled, a minimal speed change, a minimal heading change, and a combination thereof.

In exemplary embodiments there are disclosed methods comprising: in a V2X environment and by a self-vehicle, calculating a first movement similarity between the self-vehicle and a road user ahead or behind the self-vehicle, and a second movement similarity between a sensor detected road user and a road user ahead or behind the sensor detected road user, and adjusting DCC triggering condition parameters based on the calculated first and/or second movement similarities.

In some examples, the calculating the first movement similarity includes matching a parameter selected from the group consisting of distance, speed and heading between the self-vehicle and the respective road user ahead or behind, and the calculating the second movement similarity includes matching a parameter selected from the group consisting of distance, speed and heading between the sensor detected road user and the respective road user ahead or behind.

In some examples, the adjusting the DCC triggering condition parameters includes increasing from a previously transmitted value a respective value of a parameter selected from the group consisting of a minimal distance travelled, a minimal speed change, a minimal heading change, and a combination thereof.

In some examples, the calculating a first movement similarity between the self-vehicle and a road user ahead or behind the self-vehicle includes checking if the self-vehicle and the road user ahead or behind are distanced by more than a given time value when fast or distanced less than a given distance value when slow, and the calculating a second movement similarity between a sensor detected road user and a road user ahead or behind the sensor detected road user includes checking if the sensor detected road user and the road user ahead or behind are distanced by more than a given time value when fast or distanced less than a given distance value when slow.

In some examples, a method further comprises using the adjusted DCC triggering condition parameters to control transmission of both V2X Day1 and V2X Day2 information on a single channel.

In an exemplary embodiment, there is provided, in a V2X environment, a system (or ‘apparatus”) installed in a self-vehicle and comprising a V2X Day1 communication module for transmitting and receiving Day1 messages that include data of the self-vehicle; a V2X Day2 communication module for transmitting and receiving Day2 sensor sharing messages that include data of sensor detected road users; a first database for storing data of V2X detected road users; a second database a first database for storing data of the sensor detected road users; a safety relevance and/or movement similarity calculation module for determining road user safety relevance and/or movement similarity; and a DCC module for determining triggering conditions based on the safety relevance and/or movement similarity and on channel load.

### BRIEF DESCRIPTION OF THE DRAWINGS

Non-limiting examples of embodiments disclosed herein are described below with reference to figures attached hereto that are listed following this paragraph. The drawings and descriptions are meant to illuminate and clarify embodiments disclosed herein and should not be considered limiting in any way. Like elements in different drawings may be indicated by like numerals. Elements in the drawings are not necessarily drawn to scale.

FIG. 1 illustrates a block diagram of a congestion control system;

FIG. 2 illustrates a flow chart of a congestion control method disclosed herein;

FIG. 3 illustrates a flow chart of adjusting DCC based on road user safety relevance;

FIG. 4 illustrates a flow chart of adjusting DCC based on road user movement similarity;

FIG. 5 illustrates a flow chart of road user similarity calculation;

FIG. 6 illustrates a flow chart for calculating segmented arrival time for V2X detected road users;

FIG. 7 illustrates a flow chart for calculating the arrival time of sensor detected road users;

FIG. 8 illustrates a flow chart providing details of the adjusting of DCC parameters based on movement similarity;

FIG. 9 illustrates a flow chart of arrival time threshold calculation;

FIG. 10A illustrates an example of use of a method disclosed herein in an intersection with multiple road users;

FIG. 10B illustrates an example of use of a method disclosed herein in a road with multiple road users.

### DETAILED DESCRIPTION

Embodiments disclosed herein relate generally to methods and systems for safety relevance and movement similarity V2X transmission congestion control, and in particular, to methods and systems for minimizing transmission frequency based on the potential safety relevance of road users and/or their movement similarity to vehicles with V2X. For simplicity, hereinafter “road user” and “vehicle” may be used interchangeably.

Definitions of various road users:

“V2X detected road user”: road user that was not detected by self-vehicle sensors but known through information received via V2X.

“sensor detected road user”: road user without V2X and was detected by self-vehicle sensors, the information of which is transmitted in Day2 V2X messages;

“V2X and sensor detected road user”: a road user that has V2X and was detected by self-vehicle sensors, the information of which is not transmitted by a self-vehicle;

A road user is “ahead” of another road user if driving in the same lane in front of it. Similarly, a road user is “behind” another road user if driving in the same lane behind it.

A method or algorithm (and associated system/apparatus) disclosed herein (also referred to as method/system for safety relevance and movement similarity V2X transmission congestion control) performs congestion control by estimating the safety relevance to or by road users, and estimating the movement similarity of a self-vehicle or sensor detected road user with road users ahead and behind. All actions below are performed by and in a self-vehicle. The suggested algorithm decreases the transmission rate below the rate of the known ETSI congestion control method. The method assesses safety relevance, as reflected in the time leading to a collision (marked “arrival time”) between the two types of road users, sensor detected road users and potential risking V2X detected road users. To clarify, “safety relevance” refers herein to the ability of a road user to impose a risk on other road users within a given period of time (e.g. the next few seconds). The method further assesses movement similarity between the self-vehicle and sensor detected road users, to lower the transmission frequency is possible. To clarify, “movement similarity” refers to a correlation of road user movement with movements of nearby road users.

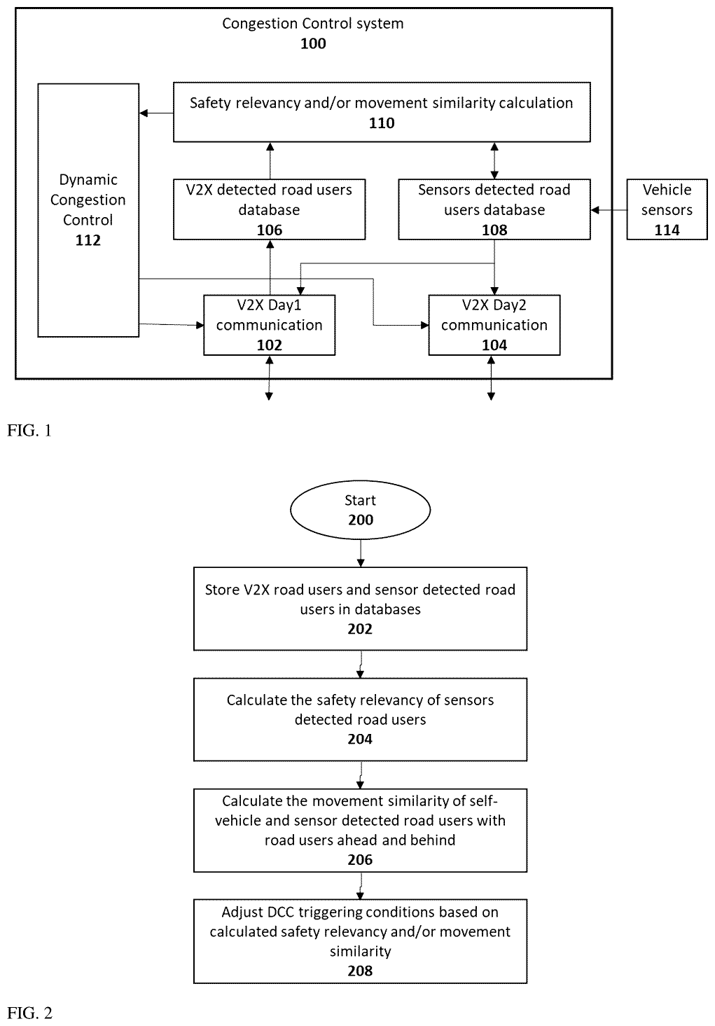

FIG. 1 illustrates a block diagram of a congestion control system disclosed herein and numbered 100. System 100 is installed for example in a vehicle that acts as a self-vehicle (and which performs the method), and comprises a V2X Day1 communication module 102, a V2X Day2 communication module 104, a first database 106, a second database 108, a safety relevance and/or movement similarity calculation module 110 and a Dynamic Congestion Control (DCC) module 112. Modules 102 and 104 may be implemented as or include a comination of hardware (HW) and software (SW). All other modules and databases may for example be implemented in SW. The function of each module and database is described in detail below.

V2X Day1 communication module 102 is used for transmitting and receiving Day1 messages that include the parameters of the self-vehicle. A congestion control method disclosed herein enables and allows to transmit also Day2 messages that include parameters of sensor detected road users 114 using the Day1 channel. V2X Day2 communication module 104 is used for transmitting and receiving Day2 sensor sharing (also called “cooperative perception”) messages, if such messages are not transmitted in the Day1 channel. Day2 communication module 104 may use a 5G C-V2X physical layer, as defined by the 3GPP Release 16 standard, or alternatively by the IEEE802.11bd standard. Data (e.g. IDs and parameters) of all the V2X detected road users are stored in first database 106. Database 106 stores the location, speed, and heading of each vehicle and the channel in which it was detected (i.e. the channel the vehicle used for transmission). Database 106 is updated upon reception of messages from either Day1 communication module 102 or messages from nearby vehicles. If no message was received from any vehicle that is currently in the database after a certain time, for example, 1 second, the entry of that vehicle is deleted from the database. Data (e.g. IDs and parameters) of sensor detected road users are stored in second database 108. The data of those road users is transmitted in Day2 messages, either using Day2 communication module 104, as in the known art, or using Day1 module 102, as enabled herein. Vehicle sensors 114 may be any sensor, camera, radar, or a Lidar, installed in the self-vehicle.

Each road user entry in 108 includes two fields in addition to kinematic attributes (e.g. location, speed and heading):
“Redundant”: a road user that is received by another Day2 vehicle. The field is defined by ETSI, and if set, the “detected road user” is not transmitted. The setting of this field is defined in prior art, and not affected by the proposed method.
“Relevant”: a road user that is safety-relevant as determined by module 110.

Safety relevance and/or movement similarity calculation module 110 is added with this disclosure to a known-art system to determine road user safety relevance and/or to determine movement similarity. When the wireless channel is not congested, all road users can be transmitted. However, when the wireless channel is congested, only the safety-relevant road users and/or those that cannot be represented by nearby road users should be transmitted. In contrast with known art, where all road users have the same priority and during congestion all are transmitted less often, here only the non-safety-relevant are transmitted less often, while the safety-relevant ones are transmitted with the same periodicity as known. For example, the transmission of a slow-moving vehicle far away from any other road users can be skipped, while fast vehicles in proximity of other road users should be transmitted.

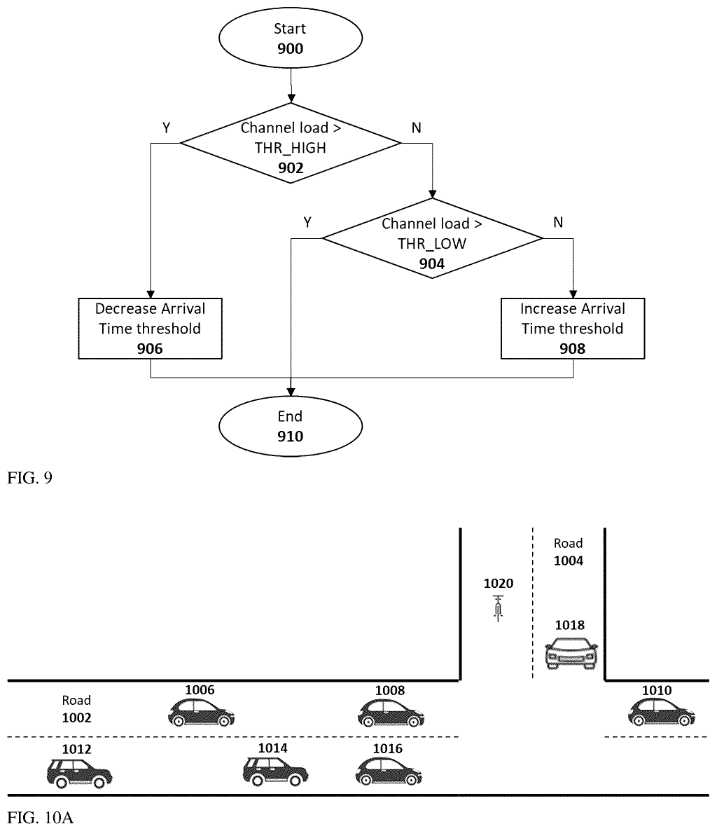

DCC module 112 is used to determine and adjust “triggering conditions” based on safety-relevancy, movement similarity and channel load (for the latter, see e.g. FIG. 9). Triggering conditions determine if a sensor detected road user should be transmitted based on changes in its location, speed and heading from its last transmission. The current ETSI specification defines fixed triggering conditions. A method disclosed herein adjusts the triggering conditions to reduce the periodicity of transmission below the ETSI specification for further reduction of channel load. “Channel load” is defined as a percentage of activity. For example, 80% activity means that energy is measured 80% of the time in the channel. The goal of the DCC algorithm is to keep the channel load lower than 60-70% by reducing the amount of transmissions. The transmission periodicity reduction disclosed herein is performed if the road user has low safety relevance (“non-safety relevant”) or if its movement is similar to other road users ahead or behind it.

FIG. 2 illustrates a flow chart of a congestion control method disclosed herein. Operation starts at step 200, for example periodically (i.e. every 100 mS), or after a message was received or if the road users were sensor detected road users. Next, in step 202, databases 106 and 108 that store the data of, respectively, the V2X detected road users and sensor detected road users, are updated accordingly. Next, in step 204, the safety relevance of the road users detected by the self-vehicle sensors is calculated. The safety relevance is derived from the expected time in which the road user detected by the self-vehicle sensors will potentially hit another road user. Next, in step 206, the movement similarity of the self-vehicle and of the sensor detected road users is calculated. The movement similarity is calculated vs. the road users ahead and behind. Steps 204 and 206 are performed in safety relevance and/or movement similarity calculation module 110. Next, in step 208, the DCC triggering condition parameters are adjusted in DCC 112 based on the calculated safety relevance and/or movement similarity. Note that the default ETSI triggering condition parameters are that 4 meters must have passed (change in location) from the previous transmission, or the change in speed should be higher than 0.5 m/s and the change in heading should be higher than 4 degrees. FIG. 8 shows how those parameters are adjusted. All the values are doubled, and that would half the periodicity. By reducing the periodicity of transmission, it is possible to fit more messages inside the channel. The output is provided to modules 102 and 104, which are responsible for transmitting on a single channel.

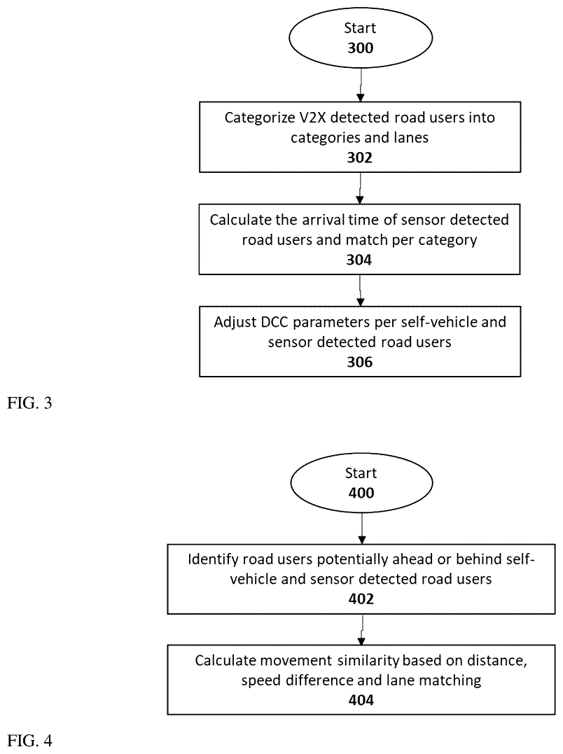

FIG. 3 provides more details of step 204 of FIG. 2. The operation expands step 204, and begins at step 300 whenever step 204 is called. Next, in step 302, the V2X detected road users are categorized into segments. The categorization (“segmentation”) divides road users into 3 categories (segments) based on their direction of arrival relative to the self-vehicle: same direction, opposite direction, and perpendicular direction. Each category of road user has a different “arrival time” (see also below), a term replacing here the common industry definition of Time-To-Collision (TTC) as the time before two road users are expected to collide into each other. TTC is problematic for representing a gap between vehicles moving in the same direction, because if the self-vehicle and the other road user have the same speed, then TTC would be infinite. The arrival time provides an accurate representation of a potential collision time in this case.

Each category has a respective arrival time (“segmented arrival time”): For road users moving in the same direction, “arrival time” is calculated as the distance Road users/max(self-vehicle speed, other road user speed). For road users moving in the opposite direction opposite directions, “arrival time” is identical to TTC and calculated as distance between Road users/(self-vehicle speed+other road user speed). For road users in perpendicular directions, “arrival time” is similar to TTC, equal to perpendicular distance/perpendicular road user speed.

Without segmentation, a brute force calculation for every pair of vehicle and road user would be needed, implying O(NM) time complexity. For example, 100 nearby vehicles and 30 road users in database 108 would require 3000 TTC calculations. Instead, a method based on segmented arrival time as disclosed herein reduces complexity to O(N)+O(M) or only 130 calculations for the same example.

Next, in step 304, the arrival time of sensor detected road users is calculated. Next, in step 306, DCC is adjusted per self-vehicle and sensor detected road users. The potential collision is between sensor detected road users and V2X detected road users. The known art assesses a potential collision between the self-vehicle and other road users. Here, the proposed scheme extends the assessment to the sensor detected road users. When the channel load is high, an arrival time threshold (see also below) is decreased to reduce the number of transmitted road users. When the channel load is low, the arrival time threshold is increased. Step 306 is performed once a second, less often than the previous steps, hence it is skipped 9 times every 10 runs.

FIG. 4 provides more details of step 206 of FIG. 2. The operation is performed in module 110 of the self-vehicle. The operation begins at step 400 when step 206 is called. Next, the operation continues from step 402. The road users potentially ahead or behind the self-vehicle or ahead or behind a sensor detected road user are identified. The identification uses the information stored in databases 106 and 108. When a road user is detected using V2X, it is declared as “behind” when driving in the direction previously driven by the self-vehicle or by the sensor detected road user.

Next, the operation continues from step 404. The movement similarity of the self-vehicle or of a sensor detected road user to the road users ahead and behind identified in step 402 is calculated based on distance, speed difference, and lane matching. The similarity can be a continuous value between 0, not similar, and 1, similar, or can be binary value. For the sake of simplicity, the description ahead refers to binary similarity. In order to be considered similar, the distance to road users ahead or behind should be below a second threshold, weighting the absolute distance and vehicle speed. The speed difference to road users ahead or behind should be below a third threshold, and both should drive in the same lane. These second and third thresholds are the ones mentioned above with reference to DCC module 112.

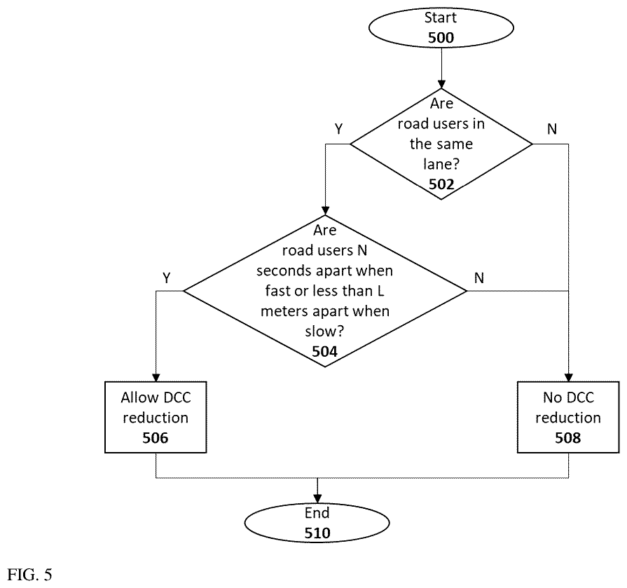

FIG. 5 illustrates a flow chart of road user movement similarity calculation, and provides more details of the various steps in FIG. 4. The operation begins in step 500 when step 404 is executed. Next, a check is performed in step 502 if the road users ahead and behind the self-vehicle or sensor detected road users are in the same lane. The logic was described in step 402. If the condition is false (i.e. the road users ahead or behind are not in the same lane as the sensor detected road user), a DCC reduction adjustment is not allowed in step 508. Next, the operation ends in step 510. Otherwise (i.e. the road users ahead or behind are in the same lane as the sensor detected road user), the operation continues to check step 504, which checks the condition “are road users N seconds apart when fast, or less than L meters apart when slow”. “Slow” may e.g. be 15 km/h, and N is typically 2 seconds, indicating the distance passed during that time. When the speed is low (“slow”), the time-based condition (N seconds apart) is never met. Therefore, an absolute distance L in meters (typically 10 m) is applied as an additional similarity condition. “Fast” is “not slow”, i.e. in the example above a speed over 15 km/h. If Yes in check 504, then the road users ahead or behind are likely similar with the sensor detected road user, and more checks are performed. The operation continues from step 506 in which DCC reduction is allowed. Maximal DCC reduction is allowed if two road users exist both ahead and behind, and medium DCC reduction is allowed if a single road user exists ahead or behind. Next, the operation ends in step 510. If No in step 504, operation continues from step 508 in which DCC reduction is not allowed. The entire operation ends in step 510.

To summarize, the movement similarity between two road users is determined in step 504. The later steps calculate how this similarity impacts the DCC parameters.

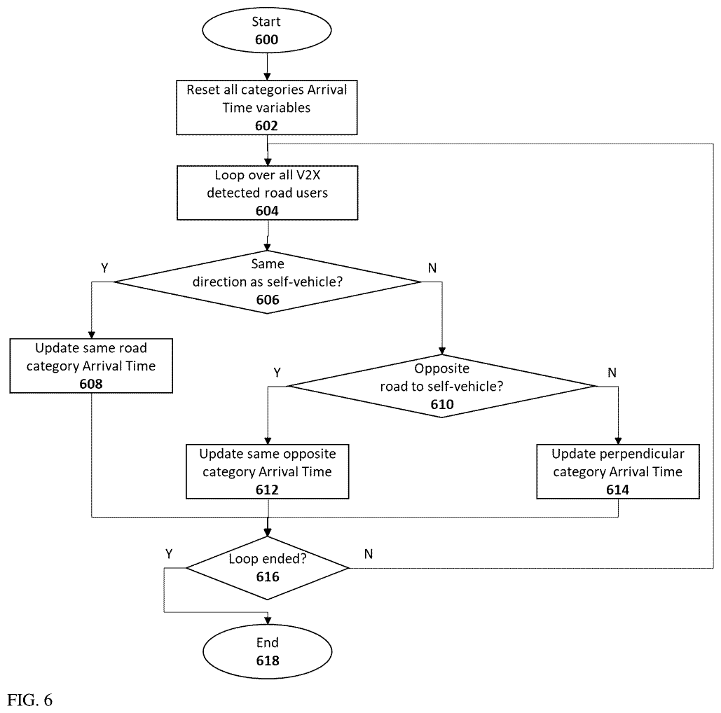

FIG. 6 illustrates a flow chart for calculating segmented arrival time for V2X detected road users. It expands the operations of step 302. The operation begins at step 600. Next, in step 602, all (3) segment Arrival Time variables are reset. These include same road Arrival Time, opposite road Arrival Time, and perpendicular road Arrival Time. The reset sets the variables to the maximal value (e.g. 15 sec) since a minimum function is applied to those. Next, in step 604, a loop begins over all road users detected by the V2X in database 106. In other words, in each iteration, a different road user from that database is checked.

Next, in step 606, a check is made if the self-vehicle and the checked road user are driving in the same direction, regardless of the driven lanes. If yes, the operation continues to step 608. The arrival time of the iterated road user is calculated according to Arrival Time=distance/max(self-vehicle speed, iterated road user speed, 5). 5 km/h is added to prevent an infinite value when both self-vehicle and iterated road user are static. Same road Arrival Time is updated to the road user's Arrival Time if lower, as Same road Arrival Time=min(same road Arrival Time, road user Arrival Time). Next, the operation continues to step 616. If the check of step 606 was false, meaning the self-vehicle and the iterated (checked) road user are not driving in the same direction, then the operation continues from step 610. A check is made if the self-vehicle and the iterated road user are driving in opposite directions. If yes, the operation continues from step 612. The arrival time of the iterated road user is calculated according to Arrival Time=distance/max(self-vehicle speed+iterated road user speed, 5). Opposite road Arrival Time is updated to road user's Arrival Time if lower, as Opposite road Arrival Time=min(Opposite road Arrival Time, road user's Arrival Time). Next, the operation continues to step 616. If check 610 was false, then the only remaining option is that the iterated road user is driving on a perpendicular road. The operation continues from step 614. The arrival time of the iterated road user is calculated according to road user Arrival Time=perpendicular distance/max(iterated road user speed, 5). Perpendicular road Arrival Time is updated to road user Arrival Time if lower, as Perpendicular road Arrival Time=min(Perpendicular road Arrival Time, road user Arrival Time). Next, the operation continues to step 616.

In step 616, the loop end is checked. If all road users in the database were iterated, the operation ends in step 618. Otherwise, the operation returns to step 604 to repeat the steps on the next iterated vehicle.

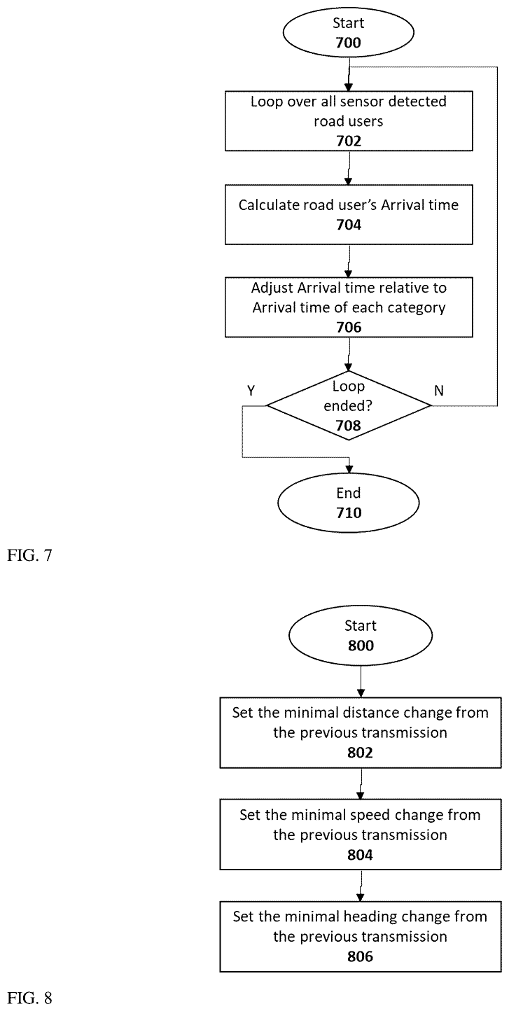

FIG. 7 illustrates a flow chart for calculating the arrival time of sensor detected road users, providing more details of step 304 of FIG. 3. The operation begins at step 700. Next, in step 702, a loop runs over all sensor detected road users database 108. In other words, in each iteration, a different road user entry is checked. Next, in step 704, the road user's Arrival Time is calculated as distance/max(speed self-vehicle, speed iterated road user, 5). Next, in step 706, the road user's Arrival Time is adjusted relative to the Arrival Time of all categories as calculated in FIG. 6. This calculation is of a relative Arrival Time between the road user and the category Arrival Time. Three checks are needed per road user detected by sensors: for the same direction, opposite direction, and perpendicular road. Perpendicular road risk is relevant only if the sensor detected road user is inside or before the intersection. If the sensor detected road user is after the intersection (i.e. the perpendicular road is between the road user and self-vehicle), then the perpendicular road risk is ignored. The calculation adjusts the road user's Arrival Time=min(the road user's Arrival Time+Same road Arrival Time, Perpendicular road Arrival Time if before intersection, Opposite road Arrival Time−the road user's Arrival Time). “Before intersection” means that there is no perpendicular road between the self-vehicle and the road user. Next, in step 708, the loop end is checked. If all road users in the database were iterated, the operation ends in step 710. Otherwise, the operation returns to step 702 to perform the steps again on the next iterated road user.

FIG. 8 illustrates a flow chart providing details of the adjusting of DCC parameters based on movement similarity. The operation begins at step 800 when step 406 is called, or when steps 508 or 510 are called. Next, in step 802, the condition of minimal distance travelled from the previous transmission is set. The default value is defined by the ETSI standard as 4 meters. When the transmission rate decreases, the minimal distance increases respectively. For example, if the rate decreases by 50% then the minimal distance is set as 8 meters. Next, in step 804, the condition of minimal speed change from the previous transmission is set. The default value is defined by the ETSI standard as 0.5 meters/second. When the transmission rate decreases, the minimal speed change increases respectively. For example, if the rate decreases by 50% then the minimal speed difference is set as 1 meter/second. Next, in step 806, the condition of minimal heading change from the previous transmission is set. The default value is defined by the ETSI standard as 4 degrees. When the transmission rate decreases, the minimal heading change increases respectively. For example, if the rate decreases by 50% then the minimal speed difference is set as 8 degrees.

FIG. 9 illustrates a flow chart of arrival time threshold calculation. It expands the operations of step 306. The operation starts at step 900. Next, in step 902, the channel load is compared with THR_HIGH. For example, THR_HIGH is 60%, which is the highest acceptable working point. If higher, the operation continues from step 906. An Arrival Time threshold, below which a road user information is transmitted, is decreased, for example, by 0.1 seconds, but not below a certain minimal value, for example, 3 seconds. Next, the operation ends in step 910. If the check of step 902 is false, and channel load is lower than THR_HIGH, then the operation continues to step 904 to check if the channel load is higher than THR_LOW. For example, THR_LOW is 35%, which is a stable working point. If higher, the operation ends at step 910. If lower, the operation continues from step 908. The Arrival Time threshold is increased, for example, by 0.1 seconds, but not above a certain maximal value, for example, 8 seconds, for quickly adopting to an increased channel load scenario. Next, the operation ends in step 910.

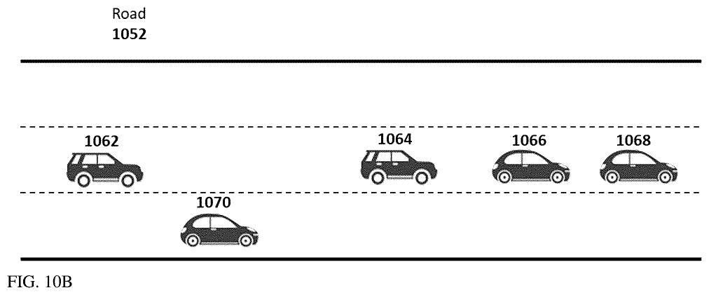

FIG. 10A illustrates an example of use of a method disclosed herein in an intersection with multiple road users. Main road 1002 and perpendical road 1004 form an intersection. Vehicles 1014, 1016 and 1018 have V2X while all other road users are not connected. In the prior art, the V2X vehicles would share all the road users detected by their sensors. That may cause a high channel load. The presented concept limits the sensor detected road users only to the ones imposing risk. The sensors of vehicle 1014 detect vehicle 1008 that can risk vehicle 1018. Yet, road users detected by vehicles 1016 and 1018 have no safety relevance to other road users and will not be transmitted.

FIG. 10B illustrates an example of use of a method disclosed herein in a road with multiple road users. All road users are driving on road 1052. Four vehicles, 1062, 1064, 1066 and 1068 are driving in the center lane, while vehicle 1070 is driving in the right lane. Since vehicle 1070 is driving alone in the lane, its movement doesn't resemble any nearby road users, and it must transmit at full rate. The gap between vehicle 1062 and the vehicle ahead 1064 is too high to be similar, hence vehicle 1062 must transmit at full rate. Vehicle 1064 is close to vehicle 1066 ahead. Therefore, vehicle 1064 transmission rate decreases by 25%. Vehicle 1066 is close to vehicle 1068 ahead, hence vehicle 1066 transmission rate is decreased by 50%.

Unless otherwise defined, all technical and scientific terms used herein have the same meaning as commonly understood by one of ordinary skill in the art. The materials, methods, and examples provided herein are illustrative only and not intended to be limiting.

It should be appreciated that the above-described methods and apparatus may be varied in many ways, including omitting, or adding steps, changing the order of steps and the type of devices used. It should be appreciated that different features may be combined in different ways. In particular, not all the features shown above in a particular embodiment or implementation are necessary in every embodiment or implementation of the disclosure. Further combinations of the above features and implementations are also considered to be within the scope of some embodiments or implementations of the disclosure.

While certain features of the described implementations have been illustrated as described herein, many modifications, substitutions, changes, and equivalents will now occur to those skilled in the art. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations and embodiments described.

What is claimed is:

1. A method, comprising: in a vehicle-to-everything (V2X) environment and by a self-vehicle:
calculating a safety relevance value of a sensor detected road user; and
adjusting Dynamic Congestion Control (DCC) triggering condition parameters based on the calculated safety relevance value.

2. The method of claim 1, wherein the calculating the safety relevance value of a sensor detected road user includes categorizing V2X detected road users by respective directions of arrival relative to the self-vehicle and checking an arrival time of each sensor detected road user in each category.

3. The method of claim 1, wherein the adjusting the DCC triggering condition parameters includes, by the self-vehicle or by a sensor detected road user found to be non-safety relevant, increasing from a previously transmitted value a respective value of a parameter selected from the group consisting of a minimal distance travelled, a minimal speed change, a minimal heading change, and a combination thereof.

4. The method of claim 1, further comprising using the adjusted DCC triggering condition parameters to control transmission of both V2X Day1 and V2X Day2 information on a single channel.

5. The method of claim 2, further comprising using the adjusted DCC triggering condition parameters to control transmission of both V2X Day1 and V2X Day2 information on a single channel.

6. The method of claim 3, further comprising using the adjusted DCC triggering condition parameters to control transmission of both V2X Day1 and V2X Day2 information on a single channel.

7. A method, comprising: in a vehicle-to-everything (V2X) environment and by a self-vehicle:
calculating a first movement similarity between the self-vehicle and a road user ahead or behind the self-vehicle, and a second movement similarity between a sensor detected road user and a road user ahead or behind the sensor detected road user; and
adjusting Dynamic Congestion Control (DCC) triggering condition parameters based on the calculated first and/or second movement similarities.

8. The method of claim 7, wherein the calculating the first movement similarity includes matching a parameter selected from the group consisting of distance, speed and heading between the self-vehicle and the respective road user ahead or behind, and wherein the calculating the second movement similarity includes matching a parameter selected from the group consisting of distance, speed and heading between the sensor detected road user and the respective road user ahead or behind.

9. The method of claim 7, wherein the adjusting the DCC triggering condition parameters includes increasing from a previously transmitted value a respective value of a parameter selected from the group consisting of a minimal distance travelled, a minimal speed change, a minimal heading change, and a combination thereof.

10. The method of claim 7, wherein the calculating a first movement similarity between the self-vehicle and a road user ahead or behind the self-vehicle includes checking if the self-vehicle and the road user ahead or behind are distanced by more than a given time value when fast or distanced less than a given distance value when slow, and wherein the calculating a second movement similarity between a sensor detected road user and a road user ahead or behind the sensor detected road user includes checking if the sensor detected road user and the road user ahead or behind are distanced by more than a given time value when fast or distanced less than a given distance value when slow.

11. The method of claim 7, further comprising using the adjusted DCC triggering condition parameters to control transmission of both V2X Day1 and V2X Day2 information on a single channel.

12. The method of claim 8, further comprising using the adjusted DCC triggering condition parameters to control transmission of both V2X Day1 and V2X Day2 information on a single channel.

13. The method of claim 9, further comprising using the adjusted DCC triggering condition parameters to control transmission of both V2X Day1 and V2X Day2 information on a single channel.

14. The method of claim 10, further comprising using the adjusted DCC triggering condition parameters to control transmission of both V2X Day1 and V2X Day2 information on a single channel.

15. In a vehicle-to-everything (V2X) environment, a system installed in a self-vehicle and comprising:
a V2X Day1 communication module for transmitting and receiving Day1 messages that include data of the self-vehicle;
a V2X Day2 communication module for transmitting and receiving Day2 sensor sharing messages that include data of sensor detected road users;
a first database for storing data of V2X detected road users;
a second database a first database for storing data of the sensor detected road users;
a safety relevance and/or movement similarity calculation module for determining road user safety relevance and/or movement similarity; and
a Dynamic Congestion Control (DCC) module for determining triggering conditions based on the safety relevance and/or movement similarity and on channel load.
